(19) United States
(12) Patent Application Publication
(10) Pub. No.: US 2006/0194905 A1
(43) Pub. Date: Aug. 31, 2006

(54) Differential adhesion masking composition

(76) Inventor: John E. Tadych, Franklin, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/236,299

(22) Filed: Sep. 27, 2005

Related U.S. Application Data
(60) Provisional application No. 60/613,274, filed on Sep. 27, 2004.

(51) Int. Cl. C08K 5/42; B05D 1/32

(52) U.S. Cl. 524/157; 427/372.2; 427/282

(57) ABSTRACT

A differential adhesion masking composition comprising a resin, hygroscopic agent, a non-silicone surfactant, solvents, optionally thickness, and optionally pigments provides greater adhesion for certain paints. The addition of pigments allows the compound to act as a self-masking paint. Method of masking and/or painting using this compound are also described.

### CROSS REFERENCE TO RELATED U.S. APPLICATION

This application claims priority from U.S. Provisional Application No. 60/613,274, filed Sep. 27, 2004 and incorporated herein by reference.

### BACKGROUND OF THE INVENTION

This invention relates generally to liquid masking compositions, and more specifically to masking compositions that can be painted over.

Differential adhesion masking compounds are known in the art, such as described in U.S. Pat. No. 6,319,548 B1 issued to Van Winckel on Nov. 20, 2001. Differential adhesion masking compounds are used to prepare surfaces for painting when such surfaces are adjacent to other surfaces that need to be masked from the paint (e.g., masking window glass within a window frame prior to painting the window). The differential adhesion masking compound adheres more strongly to the surface to be painted (e.g., wood or metal) and less strongly to masked surfaces such as glass. The masking compound is applied over the surface to be masked along with at least some of the surface to be painted. After the paint is applied, the masking compound can be easily removed from the masked glass surface while remaining in place over the painted frame surface.

Although differential masking compounds have been used successfully in many applications, the known masking compounds are not suitable for all applications. In particular, certain paint formulations do not adhere well to the differential masking compound and will form bubbles or cracks. Therefore, there is a need for a differential masking compound that can be used in more applications.

### BRIEF SUMMARY OF THE INVENTION

In one embodiment, the invention is a differential adhesion masking compound comprising a resin, a hygroscopic agent and a non-silicon surfactant, wherein, when dry, the compound will have a greater cohesive force than an adhesive force to glass.

### DETAILED DESCRIPTION OF THE INVENTION

Certain paints, such as Sherwin-Williams® paints, form bubbles over surfaces masked by known differential masking compounds. The inventor has now found that use of non-silicone surfactants/defoamers, instead of silicone containing surfactants, in the differential masking compound improve adhesion of the paint coating to the masking compound and solve the bubble formation problem. Replacement of a silicone surfactant with a non-silicone surfactant resolved the bubbling issue and eliminated customer complaints on this issue.

A typical composition of this invention will comprise a resin, hygroscopic agents, surfactants, solvents, and optionally thickeners and/or pigments.

Resin is a general term applied to a wide variety of more or less transparent and fusible products, which may be natural or synthetic. Higher molecular weight synthetic resins are generally referred to as polymers. Resin may also refer to a solid, semi-solid, or pseudo-solid organic material that has an indefinite and often high molecular weight, exhibits a tendency to flow when subjected to stress, usually has a softening or melting range, and usually fractures conchoidally. In a broader sense, the term “resin” is used to designate any polymer that is a basic material for coatings and plastics. Suitable resins can be acrylic resins, polyvinyl acetate resins, latex and alkyd resins.

Acrylic resins, also known as acrylate resins, are generally thermoplastic polymers or copolymers of acrylic acid, methacrylic acid, esters of these acids, or acrylonitrile. Typically, acrylic resins are produced by the polymerization of derivatives of acrylic acids, including esters of acrylic acid, methacrylic acid, acrylonitrile, and their copolymers. Acrylic resins which have established a pre-eminent position among coating formulators, having shown superiority in such respects as color and gloss retention, alkali and oxidation (chalk) resistance, hardness, adhesive and cohesive strength, and overall film durability.

An alkyd is a thermosetting coating polymer, chemically similar to polyester resins, conventionally made by condensation and polymerization of a dihydric or polyhydric alcohol (ethylene glycol or glycerol) and a polybasic acid (phthalic anhydride), usually with a drying oil modifier. They may be regarded as complex esters. The most common polyhydric alcohol used is glycerol, and the most common polybasic acid is phthalic anhydride. Modified alkyds are those in which the polybasic acid is substituted in part by a monobasic acid, of which the vegetable oil fatty acids are typical.

A latex is a stable dispersion of a polymeric substance in an essentially aqueous medium. Typically, a latex is a fine dispersion of rubber or resin, natural or synthetic, in water; the synthetic is made by emulsion polymerization. (Strictly speaking, after polymerization a latex is a solid dispersed in water, and therefore is not an emulsion. Latex and emulsion are often used synonymously in the paint industry.)

Polyvinyl acetate is a thermoplastic polymer obtained by polymerization of vinyl acetate and used as a latex binder.

Any hydroscopic agent is suitable for this invention but, typically, the hygroscopic agents will be glycerol or a glycol, for example, ethylene glycol or propylene glycol or a glycol ether. Other hygroscopic agents are listed in U.S. Pat. No. 6,319,548, disclosure of which agents is incorporated herein by reference.

The surfactant is a non-silicone surfactant. The term is derived from surface active Agent. A surfactant is a compound that contains a hydrophilic and a hydrophobic segment. When added to water or solvents, a surfactant reduces the surface tension of the systems for of the following purposes: wetting, emulsifying, dispersing, foaming, scouring or lubricity. Other surfactants include primary alcohol ethoxylates, octyl phenol ethoxylate, nonyl phenol ethoxylates, EO/PO non-ionics, including alcohol ethoxylates and alkyl phenol ethoxylates, fatty amine oxides, alkanolamides, EO/PO block copolymers, alkyl amine ethoxylates, quarternary ammonium compounds, imidazolines, betaines, linear alkylbenzene sulphonic acid, sodium lauryl ether sulphate, alpha olefin sulphonates, phosphate esters, sodium sulphosuccinates. One convenient class of surfactant is the sodium sulpho succinates, particularly sodium bistridecyl sulfo-succinate. Non-silicone surfactants are commercially available, such as Surfonyl® MD-20 Defoamer from Air Products and Chemicals, Inc.

Solvents will typically be water, and known resin solvents such as pyyrolidones and ethers.

Thickening agents can be resins, such as polyurethane resins, clays or other thickeners known in the art.

An example formula for the inventive masking compound is shown in Table 1.

TABLE 1
Differential Adhesion Masking Compound

| | Formula |
|---|---|
| Ingredient | Percentage |
| Rhoplex ® MC-1834; aqueous acrylic polymer emulsion | 82.83% |
| Surfonyl ® MD-20 Defoamer; Oxirane,[[(2- | |
| ethyhexyl)oxy]methyl]-, reaction product | 1.02% |
| with polyethylene glycol ether with 2,4,7,9-tetramethyl-5- | |
| decyne-4-,7-diol(2:1) | |
| Hot Water | 8.33% |
| Attagel ® 50; attapulgite clay | 1.01% |
| Acrysol ® RM-8 thickening agent; polyurethane resin/ | 1.52% |
| propylene glycol/water at about 35:39:26 ratio | |
| m-Pyrol ® solvent; n-methyl-2-pyrrolidine | 1.01% |
| Aerosol ® TR-70 surfactant; sodium bistridecyl | 3.28% |
| sulfosuccinate in mixture of ethanol and water | |
| Hexyl carbitol ®; diethylene glycol monohexyl ether | 1.01% |
| Total | 100.00% |

This inventive masking compound can be applied to many different substrates to be painted, such as wood, cement, plaster, masonry, and/or metal. The surface to be painted can be bare, primed or previously painted. The surface to be masked is usually glass but may also be ceramic, polished metal, etc. A typical application is to prepare a window for painting.

In another embodiment, pigments and toners may be added so that the compound serves as a paint and not merely as a sacrificial masking layer. Any substance, usually in the form of a dry powder, that imparts color to another substance or mixture is a pigment. Most pigments are insoluble in organic solvents and water; exceptions are the natural organic pigments, such as chlorophyll, which are generally organosoluble. To qualify as a pigment, a material must have positive colorant value. This definition excludes whiting, barites, clays, and talc. Some pigments, such as zinc oxide, and carbon black are also reinforcing agents, but the two terms are not synonymous; in the parlance of the paint and rubber industries these distinctions are not always observed. Pigments are classified as follows: (1) Inorganic (a) metallic oxides (iron, titanium, zinc, cobalt, chromium); (b) metal powder suspensions (gold, aluminum); (c) earth colors (siennas, ochers, umbers); (d) lead chromates; (e) carbon black; (2) Organic (a) animal (rhodopsin, melanin); (b) vegetable (chlorophyll, xanthophylls, indigo, flavone, carotene); (c) synthetic (phthalocyanine, lithos, toluidine, para red, toners, lakes, etc.). Pigments are very fine powders that provide colour and the ability to hide the underlying surface. Pigments are substantially insoluble in the vehicle so that thy hid the underlying surface when present in suitable concentration. Pigments must also be small to provide hiding power. The influence of particle size is illustrated by titanium dioxide, which has great hiding power at a size of 0.2 to 0.3 micron, but is a perfectly clear crystal in a large size (as in the gem, rutile). The optimum particle size for providing maximum hiding power is related to the refractive index of a pigment. A high refractive index is necessary for high hiding power when a pigment is dispersed in organic vehicles. If there is only a small difference between the indices of the pigment and the vehicle, light will be transmitted through the film regardless of the particle size. Some pigments that appear white in air are non-opague or non-hiding in vehicles because of their low refractive index. They are used, however, because they contribute other useful properties to the coating. The proportion of pigment to vehicle varies greatly with the type and use of the coating. In addition to hiding power, the amount of pigment in the non-volatile portion of the coating affects such properties of the film as gloss, flexibility, tensile strength, permeability and washability.

The masking compound is applied over the surface to be masked as well as over some of the surface to be painted which is adjacent to the surface to be masked. For example, when painting a window, the masking compound can be applied to the window glass panes and, additionally, to at least some of the window frame. The masking compound can be applied by brush, roller or sprayer. The paint is then applied to the surface to be painted. After the painting is complete and the paint is dry, the masking compound, and any overlying paint, can be lifted from the masked surface, frequently as a single piece. The masking compound will not lift off of the painted surface. As such, the cohesive force of the dried compound is greater than the adhesive force to glass but less than the adhesive force to the surface to be painted.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A compound comprising a resin, a hygroscopic agent, and a non-silicone surfactant, wherein the compound, when dry, will have a greater cohesive force than an adhesive force to glass.

2. The compound of claim 1 further containing thickening agents.

3. The compound of claim 1 wherein the surfactant is a sodium sulfosuccinate.

4. The compound of claim 3 wherein the surfactant is a sodium bistrideayl sulfosuccinate.

5. The compound of claim 1 further comprising pigments.

6. The compound of claim 1 wherein the resin is at least one of acrylic resins polyvinyl acetate resins, latex resins or alkyd resins.

7. The compound of claim 1 wherein the hygroscopic agent is at least one of glycerol, a glycol, or a glycol ether.

8. A method of masking a glass surface that is adjacent to a surface to be painted, the method comprising:
applying a compound comprising a resin, a hygroscopic agent, and a non-silicone surfactant, wherein the compound, when dry, will have a greater cohesive force than an adhesive force to glass to the glass surface adjacent to the surface to be painted and to the surface to be painted adjacent to the glass surface; and
allowing the compound to dry.

9. The method of claim 8 further comprising removing the dried compound from the glass surface.

10. The method of claim 8 further comprising applying paint to the surface to be painted after the compound is dry.

11. The method of claim 10 further comprising removing the dried compound from the glass surface after the paint has been applied.

12. The method of claim 8 wherein the surfactant is a sodium sulfosuccinate.

13. The method of claim 12 wherein the surfactant is sodium bistrideayl sulfosuccinate.

14. The method of claim 8 wherein the resin is at least one of acrylic resins, polyvinyl acetate resins, latex resins or alkyd resins.

15. The method of claim 8, wherein the hygroscopic agent is at least one of glycerol, a glycol, or a glycol ether.

16. A method for painting an article comprising at least one glass surface that is adjacent to a surface to be painted, the method comprising:
applying a composition comprising a resin, a hygroscopic agent, and a non-silicone surfactant, wherein the compound, when dry, will have a greater cohesive force than an adhesive force to glass, and a pigment to the surface to be painted such that at least some of the composition is additionally applied to the adjacent glass surface;
allowing the composition to dry; and
removing the dried composition from the glass surface.

17. The method of claim 16 wherein the article comprises a window.

18. The method of claim 16 wherein the article is a window.

19. The method of claim 16 wherein the surfactant is a sodium sulfosuccinate.

20. The method of claim 19 wherein the surfactant is sodium bistrideayl sulfosuccinate.

21. The method of claim 16 wherein the resin is at least one of acrylic resins, polyvinyl acetate resins, latex resins or alkyd resins.

22. The method of claim 16, wherein the hygroscopic agent is at least one of glycerol, a glycol, or a glycol ether.
